(19) United States
(12) Patent Application Publication
(10) Pub. No.: US 2013/0034653 A1
(43) Pub. Date: Feb. 7, 2013

(54) ANTIREFLECTIVE SILICA COATINGS BASED ON SOL-GEL TECHNIQUE WITH CONTROLLABLE PORE SIZE, DENSITY, AND DISTRIBUTION BY MANIPULATION OF INTER-PARTICLE INTERACTIONS USING PRE-FUNCTIONALIZED PARTICLES AND ADDITIVES

(71) Applicants: Nitin Kumar, Fremont, CA (US); Nikhil D. Kalyankar, Hayward, CA (US); Zhi-Wen Sun, San Jose, CA (US)

(72) Inventors: Nitin Kumar, Fremont, CA (US); Nikhil D. Kalyankar, Hayward, CA (US); Zhi-Wen Sun, San Jose, CA (US)

(73) Assignee: INTERMOLECULAR, INC., San Jose, CA (US)

(21) Appl. No.: 13/195,151

(22) Filed: Aug. 1, 2011

(51) Int. Cl. B05D 5/06; G02B 5/22

(52) U.S. Cl. 427/162; 252/589

(57) ABSTRACT

Methods and compositions for forming durable porous low refractive index coatings on substrates are provided. In one embodiment, a method of forming a porous coating on a substrate is provided. The method comprises coating a substrate with a sol-formulation comprising a silane-based binder, silica-based nanoparticles, and an inter-particle interaction modifier for regulating interactions between the silica-based nanoparticles and annealing the coated substrate. Porous coatings formed according to the embodiments described herein demonstrate good optical properties (e.g., a low refractive index) while maintaining good mechanical durability due to the presence of the inter-particle interaction modifier. The inter-particle interaction modifier increases the strength of the particle network countering capillary forces produced during drying to maintain the porosity structure.

### BACKGROUND OF THE INVENTION

1. Field of the Invention

Embodiments of the invention relate generally to methods and compositions for forming porous low refractive index coatings on substrates.

2. Description of the Related Art

Coatings that provide low reflectivity or a high percent transmission over a broad wavelength range of light are desirable in many applications including semiconductor device manufacturing, solar cell manufacturing, glass manufacturing, and energy cell manufacturing. The transmission of light through a material causes the wavelength of the light to change, a process known as refraction, while the frequency remains unchanged thus changing the speed of light in the material. The refractive index of a material is a measure of the speed of light in that material which is generally expressed as a ratio of the speed of light in vacuum relative to that in the material. Low reflectivity coatings generally have an optimized refractive index (n) in between air (n=1) and glass (n˜1.5).

An antireflective (AR) coating is a type of low reflectivity coating applied to the surface of a transparent article to reduce reflectance of visible light from the article and enhance the transmission of such light into or through the article thus decreasing the refractive index. One method for decreasing the refractive index and enhancing the transmission of light through an AR coating is to increase the porosity of the antireflective coating. Porosity is a measure of the void spaces in a material. Although such antireflective coatings have been generally effective in providing reduced reflectivity over the visible spectrum, the coatings have suffered from deficiencies when used in certain applications. For example, it is often difficult to control pore size and shape. Further, porous AR coatings which are used in solar applications are highly susceptible to moisture absorption. Moisture absorption may lead to an increase in refractive index of the AR coating and corresponding reduction in light transmission.

Thus, there is a need for low refractive index AR coatings which exhibit increased durability and controllable pore size.

### SUMMARY OF THE INVENTION

Embodiments of the invention relate generally to methods and compositions for forming porous low refractive index coatings on substrates. In one embodiment, a method of forming a porous coating on a substrate is provided. The method comprises coating a substrate with a sol-formulation and forming a gel on the substrate by drying the sol-formulation coated on the substrate. The sol-formulation comprises a silane-based binder, silica-based nanoparticles, and an inter-particle interaction modifier for regulating interactions between the silica-based nanoparticles.

In another embodiment, a sol-formulation for forming a sol-gel is provided. The sol-formulation comprises an alcohol containing solvent, an acid or base containing catalyst, a silane based binder, silica-based nanoparticles, and an inter-particle interaction modifier for regulating interactions between the silica-based nanoparticles.

In yet another embodiment, a method of making a sol-formulation is provided. The method comprises mixing a silane-based binder, an acid or base containing catalyst, silica-based nanoparticles, an alcohol containing solvent, and an inter-particle interaction modifier for regulating interactions between the silica-based nanoparticles to form a reaction mixture by at least one of a hydrolysis and polycondensation reaction.

### BRIEF DESCRIPTION OF THE DRAWINGS

So that the manner in which the above-recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a flow chart of one embodiment of a method for forming a low refractive index porous coating on a substrate according to embodiments described herein;

FIG. 2 is a schematic diagram illustrating one embodiment of a porous coating on a glass substrate according to embodiments described herein; and

FIG. 3 is a schematic diagram illustrating one embodiment of a photovoltaic cell comprising a porous coating according to embodiments described herein.

To facilitate understanding, identical reference numerals have been used, where possible, to designate identical elements that are common to the figures. It is contemplated that elements disclosed in one embodiment may be beneficially utilized on other embodiments without specific recitation.

### DETAILED DESCRIPTION

Embodiments of the invention relate generally to methods and compositions for forming porous low refractive index coatings on substrates. More specifically, embodiments of the invention relate generally to sol-gel processes and sol-formulations for forming low refractive index coatings on substrates.

The term “binder” as used herein refers to a component used to bind together one or more types of materials in mixtures. The principal properties of a binder are adhesion and cohesion.

The term “porosity” as used herein is a measure of the void spaces in a material, and may be expressed as a fraction, the “pore fraction” of the volume of voids over the total volume, between 0 and 1, or as a percentage between 0 to 100%.

The term “sol-formulation” as used herein is a chemical solution comprising at least a silane based binder, silica-based nanoparticles, and an inter-particle interaction modifier.

The term “sol-gel process” as used herein is a process where a wet formulation (the “sol”) is dried to form a gel coating having both liquid and solid characteristics. The gel coating is then heat treated to form a solid material. This technique is valuable for the development of coatings because it is easy to implement and provides films of uniform composition and thickness.

The term “sol-gel transition point” as used herein refers to the point of transition of a sol to a gel.

The term “inter-particle interaction modifier” as used herein refers to an additive that may be added to a particle based sol-formulation to control the inter-particle interactions during the sol-gel transition. The inter-particle interaction modifier controls the packing of particles during the drying phase of the sol-formulation. The ability to control and maintain the packing structure of the particles during and after drying helps control the pore size of pores in the porous film. The inter-particle interaction modifier may also function as a stabilizer for the sol-formulation in liquid phase.

The term “solidifier” as used herein refers to any chemical compound that expedites the occurrence of the sol-gel transition point. It is believed that the solidifier increases the viscosity of the sol to form a gel.

The term “surfactant” as used herein is an organic compound that lowers the surface tension of a liquid and contains both hydrophobic groups and hydrophilic groups. Thus the surfactant contains both a water insoluble component and a water soluble component. The surfactant may also be used to stabilize colloidal sols to reduce the precipitation of solids over extended periods of storage.

The term “total ash content” as used herein refers to the amount of inorganic components remaining after combustion of the organic matter in the sol formulation by subjecting the sol formulation to high temperatures. Exemplary inorganic materials remaining after combustion of the organic matter for a sol-formulation described herein typically include silica from particles and silica from binder. However, other inorganic materials, for example, fluorine, may also be present in the total ash content after combustion. The “total ash content” is typically obtained by the following method:

1. Exposing a known quantity of a sol formulation to high temperatures greater than 600 degrees Celsius to combust the organic matter.

2. Weighing the leftover inorganic material (referred to as “ash”).

The total ash content is calculated from the following formula: total ash content (wt. %) of the sol formulation=(Weight of ash (g)/original weight of the sol formulation (g))×100.

Certain embodiments described herein relate to a wet chemical film deposition process using a specific sol-formulation including at least one silane-based binder, silica-based nanoparticles, and an inter-particle interaction modifier to produce porous anti-reflective coatings with a low refractive index (e.g., lower than glass). Typically, silica-based particles are stabilized due to the presence of negative charges on the surface of the silica-based particles that prevents the particles from aggregating. In the absence of any other interaction, the silica-based particles would not aggregate. Only the capillary forces present during solvent drying force the silica-based particles to form aggregates and a network. Use of the inter-particle interaction modifier provides control over this particle aggregation during gelling and solvent drying that eventually leads to gelation. This control creates a more stable particle network that can support capillary forces during solvent drying and minimize network collapse.

The low refractive index porous coatings formed by sol-gel processes described herein may be further developed using combinatorial methods of optimizing the sol-formulations and conditions used to create those coatings. Combinatorial methods may include any processing that varies the processing conditions in two or more substrates or regions of a substrate. The combinatorial methodology includes multiple levels of screening to select coatings for further variation and optimization. Exemplary combinatorial methods and apparatus are described in co-pending U.S. patent application Ser. No. 12/970,638, filed Dec. 16, 2010 and titled HIGH-THROUGHPUT COMBINATORIAL DIP-COATING APPARATUS AND METHODOLOGIES.

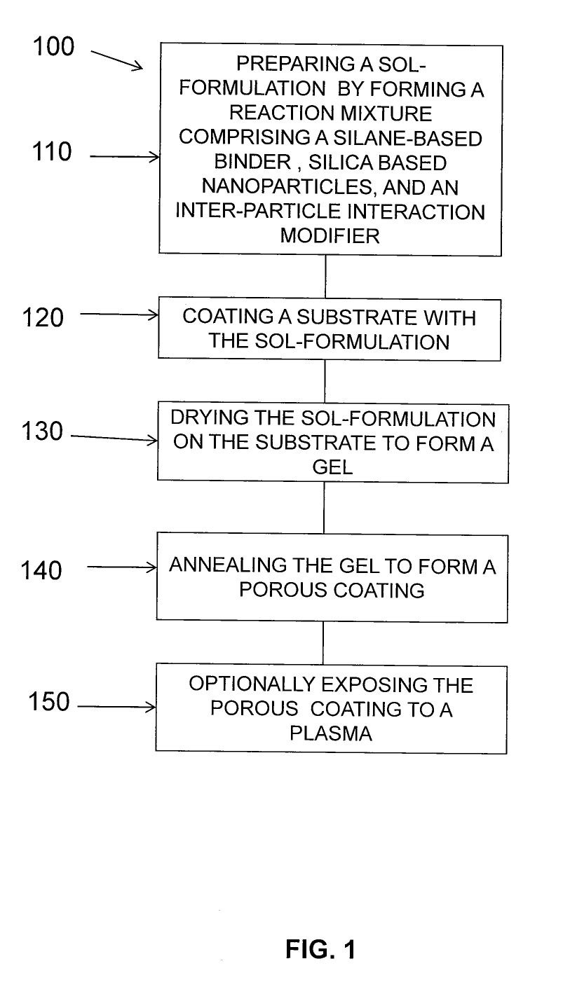

FIG. 1 is a flow chart of one embodiment of a method 100 for forming a low refractive index porous coating on a substrate according to embodiments described herein. At block 110, a sol-formulation comprising a silane-based binder, silica-based nanoparticles, and an inter-particle interaction modifier is prepared.

In one embodiment, the sol-formulation may be prepared by mixing a silane-based binder, silica-based nanoparticles, an inter-particle interaction modifier, an acid or base containing catalyst and a solvent system. The sol-formulation may be formed by at least one of a hydrolysis and polycondensation reaction. The sol-formulation may be stirred at room temperature or at an elevated temperature (e.g., 50-60 degrees Celsius) until the sol-formulation is substantially in equilibrium (e.g., for a period of 24 hours). The sol-formulation may then be cooled and additional solvents added to either reduce or increase the ash content if desired.

In one embodiment, the silane-based binder comprises a silane containing molecule having two or more reactive groups. The silane-based binder may have three or more reactive groups. The silane-based binder may have four or more reactive groups. Exemplary silanes may be selected from the group consisting of tetraethylorthosilicate (TEOS), tetramethylorthosilicate, (TMOS), tetrapropylorthosilicate, methyltriethoxysilane (MTES), methylpropoxysilane, methyltrimethoxysilane (MTMS), glycidoxipropyltrimethoxysilane (Glymo), 1,2-ethylenebis(trimethoxysilane), N-butyltrimethoxysilane, tetrabutylorthosilicate, aminoethyltrimethoxysilane, trimethoxysilane, triethoxysilane, vinyltrimethoxysilane, tetrakis(trimethylsilyloxy)silane, propyltriethoxysilane (PTES), tetrapropylorthosilicate (TPOS), ethyltriethyoxysilane (ETES), propyltriethylorthosilicate (PTES), n-butyltriethoxysilane (BTES), n-hexyltriethoxysilane, n-pentyltriethyoxysilane, n-propyltriethoxysilane, n-pentyltriethoxysilane, n-hexyltriethoxysilane, cyclohexyltrimethoxysilane, and combinations thereof.

The amount of silane-based binder in the sol-formulation may comprise at least 0.1 wt. %, 1 wt. %, 5 wt. %, 10 wt. %, 15 wt. %, 18 wt. %, or 19 wt. % of the total weight of the sol-formulation. The amount of silane-based binder in the sol-formulation may comprise up to 1 wt. %, 5 wt. %, 10 wt. %, 15 wt. %, 18 wt. %, 19 wt. %, or 20 wt. % of the total weight of the sol-formulation. The amount of the silane-based binder in the sol-formulation may be present in the sol-formulation in an amount between about 0.1 wt. % and about 20 wt. % of the total weight of the sol-formulation.

The silica-based nanoparticles may be spherical or non-spherical (e.g., elongated, pearl-shaped, or disc-shaped). The silica-based nanoparticles include silica-based nanoparticles with at least one dimension between 10 and 200 nanometers. The silica-based nanoparticles may be selected from spherical particles having a particle size from about 40 to 50 nm, spherical particles having a particle size from about 70 to 100 nm, spherical particles having a particle size from about 10 to 15 nm, spherical particles having a particle size from about 17 to 23 nm, elongated particles having a diameter from 9 to 15 nm and length of 40 to 100 nm, and combinations thereof.

The silica-based nanoparticles may be colloidal silica mono-dispersed in an organic solvent. Exemplary organic solvents include N,N-Dimethyl acetamide, ethylene glycol, isopropanol, methanol, methyl ethyl ketone, methyl isobutyl ketone, and methanol. The amount of silica-based nanoparticles present in the organic solvent may comprise between 15 wt. % and 45 wt. % of the total colloidal silica in organic solvent system. The colloidal silica in organic solvent system may comprise less than 3.0% water. The colloidal silica in organic solvent may have a viscosity less than 100 mPa·s. The colloidal silica in organic solvent may have a pH from about 2 to about 6.

Exemplary silica-based nanoparticles are available from Nissan Chemical America Corporation under the tradename ORGANOSILICASOL™. Suitable commercially available products of that type include ORGANOSILICASOL™ IPA-ST silica-based particles (particle size of 10-15 nm, 30-31 wt. % of SiO₂), ORGANOSILICASOL™ IPA-ST-L silica-based particles (particle size of 40-50 nm, 30-31 wt. % of SiO₂), ORGANOSILICASOL™ IPA-ST-MS silica-based particles (particle size of 17-23 nm, 30-31 wt. % of SiO₂), ORGANOSILICASOL™ IPA-ST-UP silica-based particles (particles have a diameter of 9-15 nm with a length of 40-100 nm, 15-16 wt. % of SiO₂), and ORGANOSILICASOL™ IPA-ST-ZL silica-based particles (particle size of 70-100 nm, 30-31 wt. % of SiO2).

Other exemplary silica based nanoparticles are available from Nissan Chemical America Corporation under the tradename SNOWTEX® colloidal silica. Suitable commercially available products of that type include SNOWTEX® ST-20L colloidal silica (particle size of 40-50 nm, 20-21 wt. % of SiO₂), SNOWTEX® ST-40 colloidal silica (particle size of 10-20 nm, 40-41 wt. % of SiO₂), SNOWTEX® ST-50 colloidal silica (particle size of 20-30 nm, 47-49 wt. % of SiO₂), SNOWTEX® ST-C colloidal silica (particle size of 10-20 nm, 20-21 wt. % of SiO₂), SNOWTEX® ST-N colloidal silica (particle size of 10-20 nm, 20-21 wt. % of SiO₂), SNOWTEX® ST-O colloidal silica (particle size of 10-20 nm, 20-21 wt. % of SiO₂), SNOWTEX® ST-OL colloidal silica (particle size of 40-50 nm, 20-21 wt. % of SiO₂), SNOWTEX® ST-ZL colloidal silica (particle size of 70-100 nm, 40-41 wt. % of SiO₂), SNOWTEX® ST-PS-M colloidal silica (particle size of 18-25 nm/80-150 nm, <0.2 wt. % of SiO₂), SNOWTEX® ST-PS-MO colloidal silica (particle size of 18-25 nm/80-150 nm, 18-19 wt. % of SiO₂), SNOWTEX® ST-PS-S colloidal silica (particle size of 10-15 nm/80-120 nm, 15-16 wt. % of SiO₂), SNOWTEX® ST-PS-O colloidal silica (particle size of 10-15 nm/80-120 nm, 15-16 wt. % of SiO₂), SNOWTEX® ST-OUP colloidal silica (particle size of 9-15 nm/40-100, 15-16 wt. % of SiO₂), and SNOWTEX® ST-UP colloidal silica (particle size of 9-15 nm/40-100 nm, <0.2 wt. % of SiO₂).

Other exemplary silica based nanoparticles are available from Nippon Shokubai Co. Ltd. under the tradename SEAHOSTAR® spherical silica particles. Suitable commercially available products of that type include SEAHOSTAR® type KE amorphous silica particles such as: SEAHOSTAR® type KE-E10 amorphous silica particles (average particle size of 0.10 μm-0.16 μm), SEAHOSTAR® type KE-W10 amorphous silica particles (average particle size of 0.09 μm-0.15 μm), and SEAHOSTAR® type KE-P10 amorphous silica particles (average particle size of 0.08 μm-0.14 μm).

Other exemplary silica-based nanoparticles are available from Purest Colloids, Inc. under the tradename MesoSilica™ nanoparticle colloidal silica (average particle size of 6 nm) and from Rockwood Additives Ltd. under the tradename LAPONITE® silica particles.

The amount of silica-based nanoparticles in the sol-formulation may comprise at least 0.01 wt. %, 0.05 wt. %, 1 wt. %, 3 wt. %., 5 wt. %, 7 wt. %, 9 wt. %, 11 wt. %, 13 wt. %. 15 wt. %, 17 wt. %, or 19 wt. % of the total weight of the sol-formulation. The amount of silica-based nanoparticles in the sol-formulation may comprise up to 0.05 wt. %, 1 wt. %, 3 wt. %., 5 wt. %, 7 wt. %, 9 wt. %, 11 wt. %, 13 wt. %, 15 wt. %, 17 wt. %, 19 wt. %, or 20 wt. % of the total weight of the sol-formulation. The amount of the silica-based nanoparticles in the sol-formulation may be present in the sol-formulation in an amount between about 0.01 wt. % and about 20 wt. % of the total weight of the sol-formulation.

The inter-particle interaction modifier may be selected from the group consisting of: polymers/molecules that adsorb onto the silica-based nanoparticles, soluble non-adsorbing polymers that cause depletion attraction forces between the silica-based nanoparticles, electrolytes, and combinations thereof. The inter-particle interaction modifier is generally selected such that it is soluble in the solvent system of the sol-formulation. Solubility of the inter-particle interaction modifier in the solvent system helps avoid phase separation prior to sol-gel transition.

The amount of inter-particle interaction modifier present in the sol-formulation is typically dependent on the solubility of the inter-particle interaction modifier in the solvent and the amount of nanoparticles in the final sol-formulation.

Polymers/molecules that adsorb onto the surface of the silica-based nanoparticles may be selected from the group consisting of: polymethylmethacrylate (PMMA), dextrin, cationic surfactants, anionic surfactants, and combinations thereof. Polymers/molecules that adsorb onto the surface of the silica-based nanoparticles are believed to neutralize or minimize the charge between silica-based nanoparticles thus creating an attractive force between the silica-based nanoparticles. In certain embodiments, the polymers/molecules may lead to particle bridging between the silica-based nanoparticles.

Exemplary anionic surfactants include sulfates, sulfonates, phosphates, carboxylates, carboxylate fluorosurfactants, and combinations thereof. Exemplary sulfates include alkyl sulfates, such as ammonium lauryl sulfate (ALS) and sodium lauryl sulfate (SLS) and alkyl ether sulfates, such as sodium laureth sulfate and sodium myreth sulfate. Exemplary sulfonates include docusates, such as dioctyl sodium sulfosuccinate, sulfonate fluorosurfactants, such as perfluorooctanesulfonate (PFOS) and perfluorobutanesulfonate, and alkyl benzene sulfonates. Exemplary phosphates include alkyl aryl ether phosphate and alkyl ether phosphate. Exemplary carboxylates include sodium stearate and sodium lauroyl sarcosinate. Exemplary carboxylate fluorosurfactants include perfluorononanoate and perfluorooctanoate (PFOA).

Exemplary cationic surfactants include pH-dependent primary, secondary or tertiary amines and charged quaternary ammonium cation. Primary amines generally become positively charged at pH less than 10 and secondary amines become charged at pH less than 4. Exemplary pH-dependent amines include octenidine dihydrochloride. Exemplary charged quaternary ammonium cations include alkyltrimethylammonium salts, such as cetyl trimethylammonium bromide (CTAB) and cetyl trimethylammonium chloride (CTAC), cetylpyridinum chloride (CPC), polyethyoxylated tallow amine (POEA), benzalkonium chloride (BAC), benzethonium chloride (BZT), 5-Bromo-5-nitro-1,3-dioxane, dimethyldioctadecylammonium chloride, dioctadecyldimethylammonium bromide (DODAB), and dodecyltrimethylammoniumchloride (DTAC).

In embodiments where the inter-particle interaction modifier is an adsorbing polymer/molecule, the adsorbing polymer/molecule may comprise at least 0.001 wt. %, 0.003 wt. %, 0.01 wt. %, 0.03 wt. %., 0.05 wt. %, 0.07 wt. %, 0.09 wt. %, 0.11 wt. %, 0.13 wt. %. 0.15 wt. %, 0.17 wt. %, or 0.19 wt. % of the total weight of the sol-formulation. The adsorbing polymer/molecule may comprise up to 0.003 wt. %, 0.01 wt. %, 0.03 wt. %., 0.05 wt. %, 0.07 wt. %, 0.09 wt. %, 0.11 wt. %, 0.13 wt. %. 0.15 wt. %, 0.17 wt. %, 0.19 wt. %, or 1 wt. % of the total weight of the sol-formulation. The amount of the adsorbing polymer/molecule in the sol-formulation may be present in the sol-formulation in an amount between about 0.001 wt. % and about 1 wt. % of the total weight of the sol-formulation.

The soluble non-adsorbing polymers may cause an attractive force, such as a depletion attraction force, between the silica-based nanoparticles. Soluble non-adsorbing polymers that cause depletion attraction forces between the silica-based nanoparticles may be selected from the group consisting of: sodium poly(styrenesulfonate), polyvinylalchol (PVA), sodium carboxymethyl cellulose (CMC), sodium polystyrene sulfonate (SPSS), hydroxyethylcellulose, hydroxymethylcellulose, monomethoxypoly(ethylene glycol), and combinations thereof.

In embodiments where the inter-particle interaction modifier is a soluble non-adsorbing polymer, the soluble non-adsorbing polymer may comprise at least 0.001 wt. %, 0.003 wt. %, 0.01 wt. %, 0.03 wt. %., 0.05 wt. %, 0.07 wt. %, 0.09 wt. %, 0.11 wt. %, 0.13 wt. %. 0.15 wt. %, 0.17 wt. %, or 0.19 wt. % of the total weight of the sol-formulation. The soluble non-adsorbing polymer may comprise up to 0.003 wt. %, 0.01 wt. %, 0.03 wt. %., 0.05 wt. %, 0.07 wt. %, 0.09 wt. %, 0.11 wt. %, 0.13 wt. %. 0.15 wt. %, 0.17 wt. %, 0.19 wt. %, or 1 wt. % of the total weight of the sol-formulation. The amount of soluble non-adsorbing polymer may be present in the sol-formulation in an amount between about 0.001 wt. % and about 1 wt. % of the total weight of the sol-formulation.

Electrolytes may be added to the sol-formulation to reduce the repulsive interaction between silica-based nanoparticles. The electrolytes are selected from the group consisting of: sodium chloride, potassium chloride, sodium nitrate, potassium nitrate, potassium bromide, potassium iodide, potassium sulfate, ammonium chloride, lead nitrate, and combinations thereof.

In embodiments where the inter-particle interaction modifier is an electrolyte, the electrolyte may comprise at least 0.001 wt. %, 0.003 wt. %, 0.01 wt. %, 0.03 wt. %., 0.05 wt. %, 0.07 wt. %, 0.09 wt. %, 0.11 wt. %, 0.13 wt. %. 0.15 wt. %, 0.17 wt. %, or 0.19 wt. % of the total weight of the sol-formulation. The electrolyte may comprise up to 0.003 wt. %, 0.01 wt. %, 0.03 wt. %., 0.05 wt. %, 0.07 wt. %, 0.09 wt. %, 0.11 wt. %, 0.13 wt. %. 0.15 wt. %, 0.17 wt. %, 0.19 wt. %, or 1 wt. % of the total weight of the sol-formulation. The amount of electrolyte may be present in the sol-formulation in an amount between about 0.001 wt. % and about 1 wt. % of the total weight of the sol-formulation. Exemplary functionalizations for silica nanoparticles may include amine, fluoro, alkyl, polymeric, and sulfate functionalizations.

In certain embodiments, the silica-based particles may be exposed to the inter-particle interaction modifier prior to sol-formulation to form a pre-functionalized silica-based nanoparticle.

The sol-formulation may further include an acid or base catalyst for controlling the rates of hydrolysis and condensation. The acid or base catalyst may be an inorganic or organic acid or base catalyst. Exemplary acid catalysts may be selected from the group consisting of hydrochloric acid (HCI), nitric acid (HNO₃), sulfuric acid (H₂SO₄), acetic acid (CH₃COOH), formic acid (HCO₂H), phosphoric acid (H₃PO₄) glycolic acid, citric acid, and combinations thereof. Exemplary base catalysts include ammonium hydroxide, tetramethylammonium hydroxide (TMAH), sodium hydroxide (NaOH), potassium hydroxide (KOH), and the like.

The acid catalyst level may be 0.001 to 10 times in stoichiometric amount compared with the silane-based binder. The acid catalyst level may be from 0.001 wt. % to 0.1 wt. % of the total weight of the sol-formulation. The base catalyst level may be from 0.001 to 10 times molar binder (the silane-based binder). The base catalyst level may be from 0.001 wt. % to 0.1 wt. % of the total weight of the sol-formulation.

The sol-formulation further includes a solvent system. The solvent system may include a non-polar solvent, a polar aprotic solvent, a polar protic solvent, and combinations thereof. Selection of the solvent system and the porosity forming agent may be used to influence the formation and size of pores. Exemplary solvents include alcohols, for example, n-butanol, isopropanol, n-propanol, ethanol, methanol, and other well known alcohols. The amount of solvent may be from 80 to 95 wt. % of the total weight of the sol-formulation.

The solvent system may further include water. Water may be present in 0.5 to 10 times in stoichiometric amount compared with the silane-based binder. Water may be present from 0.001 to 10 wt. % of the total weight of sol-formulation.

The sol-formulation may further include a surfactant. In certain embodiments, the surfactant may be used for stabilizing the sol-gel composition. In certain embodiments, the surfactant may be used as a molecular porogen which is used as a porosity forming agent. The surfactant may be selected from the group comprising: non-ionic surfactants, cationic surfactants, anionic surfactants, and combinations thereof. Exemplary non-ionic surfactants include non-ionic surfactants with linear hydrocarbon chains and non-ionic surfactants with hydrophobic trisiloxane groups. The surfactant may be a trisiloxane surfactant. Exemplary molecular porogens may be selected from the group consisting of: polyoxyethylene stearyl ether, benzoalkoniumchloride (BAC), cetyltrimethylammoniumbromide (CTAB), 3-glycidoxypropyltrimethoxysilane, polyethyleneglycol (PEG), ammonium lauryl sulfate (ALS), dodecyltrimethylammoniumchloride (DTAC), polyalkyleneoxide modified hepta-methyltrisiloxane, and combinations thereof.

Exemplary surfactants are commercially available from Momentive Performance Materials under the tradename SILWET® surfactant and from SIGMA ALDRICH® under the tradename BRIJ® surfactant. Suitable commercially available products of that type include SILWET® L-77 surfactant and BRIJ® 78 surfactant.

At block 120, a substrate is coated with the sol-formulation. Exemplary substrates include glass, silicon, metallic coated materials, or plastics. The substrate may be a transparent substrate. The substrate may be flat, curved or any other shape as necessary for the application under consideration. The substrate may be textured or patterned. Exemplary glass substrates include high transmission low iron glass, borosilicate glass (BSG), sodalime glass and standard clear glass. The sol-gel composition may be coated on the substrate using, for example, dip-coating, spin coating, curtain coating, roll coating, capillary coating or a spray coating process. Other application methods known to those skilled in the art may also be used. The substrate may be coated on a single side or on multiple sides of the substrate.

At block 130, the coating on the substrate is dried to form a gel. A gel is a coating that has both liquid and solid characteristics and may exhibit an organized material structure (e.g., a water based gel is JELL-O®). During the drying, the solvent of the sol-formulation is evaporated and further bonds between the components, or precursor molecules, may be formed. The drying may be performed by exposing the coating on the substrate to the atmosphere at room temperature. The coatings (and/or the substrates) may alternatively be exposed to a heated environment at a boiling point above the solvent, low pressure regions, or room temperature air flow to elevate the rate of solvent evaporation. The drying of the coating may not require elevated temperatures, but may vary depending on the composition of the sol-formulation used to form the coating. In one embodiment, the drying temperature may be in the range of approximately 25 degrees Celsius to approximately 200 degrees Celsius. In one embodiment, the drying temperature may be in the range of approximately 50 degrees Celsius to approximately 60 degrees Celsius. The drying process may be performed for a time period of between about 1 minute and 10 minutes, for example, about 6 minutes. Drying temperature and time are dependent on the boiling point of the solvent used during sol formation.

At block 140, the gel is annealed to form the porous coating. The annealing temperature and time may be selected based on the chemical composition of the sol-gel composition, depending on what temperatures may be required to form cross-linking between the components throughout the coating. In one embodiment, the annealing temperature may be in the range of 500 degrees Celsius and 1,000 degrees Celsius. In one embodiment, the annealing temperature may be 600 degrees Celsius or greater. In another embodiment, the annealing temperature may be between 625 degrees Celsius and 650 degrees Celsius. The annealing process may be performed for a time period of between about 3 minutes and 1 hour, for example, about 6 minutes.

The porous coating layer in one embodiment may have a thickness greater than 50 nanometers. The porous coating layer in another embodiment may have a thickness between about 50 nanometers and about 1,000 nanometers. The porous coating layer in yet another embodiment may have a thickness between about 100 nanometers and about 200 nanometers. The porous coating layer in still yet another embodiment may have a thickness of about 150 nanometers.

The porous coating layer may contain several types of porosity. Exemplary types of porosity include micropores, mesopores, and macropores. The micropores may be formed when organic material is burned off. The micropores typically have a diameter of less than 2 nanometers. The macropores and mesopores may be formed by packing of the silica nanoparticles. The macropores may have a diameter greater than 50 nanometers. The micropores may have a diameter between 2 nanometers and 50 nanometers. The porous coating may have a pore fraction of between about 0.3 and about 0.6. The porous coating may have a porosity of between about 20% and about 60% as compared to a solid film formed from the same material.

In one embodiment, the coating may be a single coating. In alternate embodiments, the coating may be formed of multiple coatings on the same substrate. In such an embodiment, the coating, gel-formation, and annealing may be repeated to form a multi-layered coating with any number of layers. The multi-layers may form a coating with graded porosity. For example, in certain embodiments it may be desirable to have a coating which has a higher porosity adjacent to air and a lower porosity adjacent to the substrate surface. A graded coating may be achieved by modifying various parameters, such as, the type of porosity forming agent in the sol-formulation, the shape and size of the inter-particle interaction modifier, the type of inter-particle interaction modifier, the anneal time, and the anneal temperature.

At block 150, the porous coating may be exposed to plasma to seal the top layer of the pores to make the film more moisture resistant while preserving the optical properties of the film. The plasma may be RF or DC plasma. In certain embodiments, the pores may be sealed using a molecular masking layer. One exemplary masking layer includes a polymeric layer which may be a few nanometers thick and doesn't significantly impact the overall refractive index of the film. Another exemplary masking layer could be a vacuum deposited metal oxide layer of 2-5 nanometers thickness such as TiO₂.

### EXAMPLES

It is believed that the following examples further illustrate the objects and advantages of the embodiments. The particular materials and amounts thereof, as well as other conditions and details, recited in these examples should not be used to limit embodiments described herein. Unless stated otherwise all percentages, parts and ratios are by weight. Examples of the invention are numbered while comparative samples, which are not examples of the invention, are designated alphabetically.

### Example #1

A sol-formulation is prepared using tetraethylorthosilicate (TEOS) as the binder, n-propanol as the solvent, acetic acid as the catalyst, ORGANOSILICASOL™ IPA-ST-UP elongated silica particles, water, and polymethylmethacrylate (PMMA) as the inter-particle interaction modifier. The total ash content of the solution is 4% (based on equivalent weight of SiO₂ produced). The ratio of silane-based binder to silica particles (TEOS:IPA-ST-UP particles) is 50:50 ash content contribution. TEOS and silica particles are mixed with water (2 times the molar TEOS amount), acetic acid (5 times the molar TEOS amount), n-propanol, and PMMA (between 0.001 wt. % and 1 wt. % of the sol-formulation). The solution is stirred for 24 hours at room temperature.

### Example #2

A sol-formulation is prepared using Tetraethylorthosilicate (TEOS) as the silane-based binder, n-propanol as the solvent, acetic acid as the catalyst, ORGANOSILICASOL™ IPA-ST-UP elongated silica particles, water, and dextrin as the inter-particle interaction modifier. The total ash content of the solution is 4% (based on equivalent weight of SiO₂ produced). The ratio of silane-based binder to silica particles (TEOS:IPA-ST-UP particles) is 50:50 ash content contribution. TEOS and silica particles are mixed with water (2 times the molar TEOS amount), acetic acid (5 times the molar TEOS amount), n-propanol, and dextrin (between 0.001 wt. % and 1 wt. %). The solution is mixed at room temperature and stirred for 24 hours at 60 degrees Celsius.

### Example #3

A sol-formulation is prepared using methyltriethoxysilane (MTES) as the silane-based binder, n-propanol as the solvent, acetic acid as the catalyst, ORGANOSILICASOL™ IPA-ST-UP elongated silica particles, water, and sodium lauryl sulfate as the inter-particle interaction modifier. The total ash content of the solution is 4% (based on equivalent weight of SiO₂ produced). The ratio of silane-based binder to silica particles (MTES:IPA-ST-UP particles) is 50:50 ash content contribution. MTES and silica particles are mixed with water (2 times the molar MTES amount), acetic acid (5 times the molar MTES amount), n-propanol, and sodium lauryl sulfate (between 0.001 wt. % and 1 wt. %). The solution is mixed at room temperature and stirred for 24 hours at 60 degrees Celsius.

### Example #4

A sol formulation is prepared using n-hexyltriethoxysilane as the silane-based binder, n-propanol as the solvent, acetic acid as the catalyst, ORGANOSILICASOL™ IPA-ST-UP elongated silica particles, water, and benzalkonium chloride as the inter-particle interaction modifier. The total ash content of the solution is 4% (based on equivalent weight of SiO₂ produced). The ratio of silane-based binder to silica particles (Binder:IPA-ST-UP particles) is 50:50 ash content contribution. N-hexyltriethoxysilane and silica particles are mixed with water (2 times the molar binder amount), acetic acid (5 times the molar binder amount), n-propanol, and benzalkonium chloride (between 0.001 wt. % and 1 wt. %). The solution is stirred for 24 hours at room temperature.

### Example #5

A sol formulation is prepared using n-hexyltriethoxysilane as the silane-based binder, n-propanol as the solvent, acetic acid as the catalyst, ORGANOSILICASOL™ IPA-ST-UP elongated silica particles, water, and sodium polystyrene sulfonate as the inter-particle interaction modifier. The total ash content of the solution is 8% (based on equivalent weight of SiO₂ produced). The ratio of silane-based binder to silica particles (n-hexyltriethoxysilane:IPA-ST-UP particles) is 70:30 ash content contribution. N-hexyltriethoxysilane and silica particles are mixed with water (2 times the molar n-hexyltriethoxysilane amount), acetic acid (5 times the molar n-hexyltriethoxysilane amount), n-propanol, and sodium polystyrene sulfonate (between 0.001 wt. % and 1 wt. %). The solution is stirred for 24 hours at room temperature.

### Example #6

A sol formulation is prepared using n-hexyltriethoxysilane as the silane-based binder, n-propanol as the solvent, acetic acid as the catalyst, ORGANOSILICASOL™ IPA-ST-UP elongated silica particles, water, and polyvinylalcohol (PVA) as the inter-particle interaction modifier. The total ash content of the solution is 4% (based on equivalent weight of SiO₂ produced). The ratio of silane-based binder to silica particles (N-hexyltriethoxysilane:IPA-ST-UP particles) is 60:40 ash content contribution. N-hexyltriethoxysilane and silica particles are mixed with water (2 times the molar n-hexyltriethoxysilane amount), acetic acid (5 times the molar n-hexyltriethoxysilane amount), n-propanol, and polyvinylalchol (between 0.001 wt. % and 1 wt. %). The solution is stirred for 24 hours at room temperature.

### Example #7

A sol formulation is prepared using cyclohexyltrimethoxysilane as the silane-based binder, n-propanol as the solvent, nitric acid as the catalyst, ORGANOSILICASOL™ IPA-ST-UP elongated silica particles, water, and sodium carboxymethyl cellulose (CMC) as the inter-particle interaction modifier. The total ash content of the solution is 10% (based on equivalent weight of SiO₂ produced). The ratio of silane-based binder to silica particles (binder:IPA-ST-UP particles) is 50:50 ash content contribution. Cyclohexyltrimethoxysilane and silica particles are mixed with water (2 times the molar cyclohexyltrimethoxysilane amount), nitric acid (5 times the molar cyclohexyltrimethoxysilane amount), n-propanol, and sodium carboxymethyl cellulose (between 0.001 wt. % and 1 wt. %). The solution is stirred for 24 hours at room temperature.

### Example #8

A sol-formulation is prepared using Tetraethylorthosilicate (TEOS) as the silane-based binder, n-propanol as the solvent, acetic acid as the catalyst, ORGANOSILICASOL™ IPA-ST-UP elongated silica particles, water, and potassium chloride as the inter-particle interaction modifier. The total ash content of the solution is 4% (based on equivalent weight of SiO₂ produced). The ratio of silane-based binder to silica particles (TEOS:IPA-ST-UP particles) is 50:50 ash content contribution. TEOS and silica particles are mixed with water (2 times the molar TEOS amount), acetic acid (5 times the molar TEOS amount), n-propanol, and potassium chloride (between 0.001 wt. % and 1 wt. % of the sol-formulation). The solution is stirred for 24 hours at elevated temperature (60 degrees Celsius).

### Example #9

Tetraethylorthosilicate (TEOS) corresponding to 6% total ash content (based on equivalent weight of SiO₂ produced) in the final formulation was mixed with water (2 times stoichiometric amount based on TEOS), tetraethylammonium hydroxide (0.02 times the molar TEOS amount) and n-propanol (10-100 times molar TEOS). The solution was stirred for 24 hours at room temperature or elevated temperature (50-60 degrees Celsius). The solution was cooled to room temperature and mixed with an additional amount of n-propanol to bring the total ash content of the solution to ˜3%. BRIJ® 78 surfactant was added to this solution at 3% mass level to act as a porogen and PMMA (between 0.001 wt. % and 1 wt. % of the sol-formulation) was added to act as inter particle interaction modifier.

### Example #10

Methyltriethoxysilane (MTES) corresponding to 3% total ash content (based on equivalent weight of SiO₂ produced) in the final formulation was mixed with water (2 times stoichiometric amount based on MTES), nitric acid (0.02 times the molar MTES amount) and n-propanol (10-100 times molar TEOS). The solution was stirred for 24 hours at room temperature or elevated temperature (50-60 degrees Celsius). The solution was cooled to room temperature and mixed with an additional amount of n-propanol to bring the total ash content of the solution to 3%. SILWET® L-77 surfactant was added to this solution at 3% mass level to act as a porogen and potassium chloride (between 0.001 wt. % and 1 wt. % of the sol-formulation) was added as inter-particle interaction modifier.

### Example #11

Propyltriethylorthosilane (PTES) corresponding to 3% total ash content (based on equivalent weight of SiO₂ produced) in the final formulation was mixed with water (2 times stoichiometric amount based on PTES), nitric acid (0.02 times the molar PTES amount) and n-propanol (10-100 times molar PTES). The solution was stirred for 24 hours at room temperature or elevated temperature (50-60 degrees Celsius). The solution was cooled to room temperature and mixed with an additional amount of n-propanol to bring the total ash content of the solution to 3%. SILWET® L-77 surfactant was added to this solution at 3% mass level to act as a porogen. Dextrin (between 0.001 wt. % and 1 wt. %) was added to act as the inter-particle interaction modifier.

### Example #12

A sol-formulation is prepared using Tetramethylorthosilicate (TMOS) as the silane-based binder, n-propanol as the solvent, acetic acid as the catalyst, ORGANOSILICASOL™ IPA-ST-UP elongated silica particles, water, and dextrin as the inter-particle interaction modifier. The total ash content of the solution is 10% (based on equivalent weight of SiO₂ produced). The ratio of silane-based binder to silica particles (TMOS:IPA-ST-UP particles) is 50:50 ash content contribution. TMOS and silica particles are mixed with water (2 times the molar TMOS amount), acetic acid (5 times the molar TMOS amount), n-propanol, and dextrin (between 0.001 wt. % and 1 wt. %). The solution is mixed at room temperature and stirred for 24 hours at 60 degrees Celsius.

### Example #13

A sol formulation is prepared using n-butyltriethoxysilane (BTES) as the silane-based binder, ethanol as the solvent, nitric acid as the catalyst, ORGANOSILICASOL™ IPA-ST-L spherical silica particles, water, and sodium carboxymethyl cellulose (CMC) as the inter-particle interaction modifier. The total ash content of the solution is 10% (based on equivalent weight of SiO₂ produced). The ratio of silane-based binder to silica particles (binder:IPA-ST-L particles) is 60:40 ash content contribution. BTES and silica particles are mixed with water (2 times the molar BTES amount), nitric acid (5 times the molar BTES amount), n-propanol, and sodium carboxymethyl cellulose (between 0.001 wt. % and 1 wt. %). The solution is stirred for 24 hours at room temperature.

### Example #14

A sol formulation is prepared using n-hexyltriethoxysilane as the silane-based binder, n-propanol as the solvent, acetic acid as the catalyst, ORGANOSILICASOL™ IPA-ST-UP elongated silica particles, water, and polyvinylalcohol (PVA) and dextrin as the inter-particle interaction modifiers. The total ash content of the solution is 8% (based on equivalent weight of SiO₂ produced). The ratio of silane-based binder to silica particles (N-hexyltriethoxysilane:IPA-ST-UP particles) is 40:60 ash content contribution. N-hexyltriethoxysilane and silica particles are mixed with water (2 times the molar n-hexyltriethoxysilane amount), acetic acid (5 times the molar n-hexyltriethoxysilane amount), n-propanol, and polyvinylalcohol and dextrin (between 0.001 wt. % and 1 wt. %). The solution is stirred for 24 hours at room temperature.

### Example #15

A sol formulation is prepared using n-pentyltriethoxysilane as the silane-based binder, n-butanol as the solvent, acetic acid as the catalyst, ORGANOSILICASOL™ IPA-ST-MS spherical silica nanoparticles, water, and benzalkonium chloride as the inter-particle interaction modifier. The total ash content of the solution is 12% (based on equivalent weight of SiO₂ produced). The ratio of silane-based binder to silica particles (Binder:IPA-ST-MS particles) is 30:70 ash content contribution. N-pentyltriethoxysilane and silica particles are mixed with water (5 times the molar binder amount), acetic acid (0.1 times the molar binder amount), n-butanol, and benzalkonium chloride (between 0.001 wt. % and 1 wt. %). The solution is stirred for 24 hours at room temperature.

### Example #16

A sol-formulation is prepared using methyltriethoxysilane (MTES) as the silane-based binder, n-propanol as the solvent, acetic acid as the catalyst, ORGANOSILICASOL™ IPA-ST-ZL spherical silica nanoparticles, water, and sodium lauryl sulfate as the inter-particle interaction modifier. The total ash content of the solution is 8% (based on equivalent weight of SiO₂ produced). The ratio of silane-based binder to silica particles (MTES:IPA-ST-ZL particles) is 45:55 ash content contribution. MTES and silica particles are mixed with water (10 times the molar MTES amount), acetic acid (5 times the molar MTES amount), n-propanol, and sodium lauryl sulfate (between 0.001 wt. % and 1 wt. %). The solution is mixed at room temperature and stirred for 24 hours at 60 degrees Celsius.

### Example #17

A sol-formulation is prepared using methyltriethoxysilane (MTES) as the silane-based binder, n-propanol as the solvent, hydrochloric acid as the catalyst, a mixture of ORGANOSILICASOL™ IPA-ST-ZL spherical and IPA-ST-UP elongated silica nanoparticles (50:50 by mass), water, and sodium lauryl sulfate as the inter-particle interaction modifier. The total ash content of the solution is 8% (based on equivalent weight of SiO₂ produced). The ratio of silane-based binder to silica particles (MTES:silica nano-particles) is 45:55 ash content contribution. MTES and silica particles are mixed with water (10 times the molar MTES amount), hydrochloric acid (0.05 times the molar MTES amount), n-propanol, and sodium lauryl sulfate (between 0.001 wt. % and 1 wt. %). The solution is mixed at room temperature and stirred for 24 hours at 60 degrees Celsius.

### Example #18

A sol formulation is prepared using n-hexyltriethoxysilane as the silane-based binder, ethanol as the solvent, sulfuric acid as the catalyst, ORGANOSILICASOL™ IPA-ST-S spherical silica nanoparticles, water, and polyvinylalcohol (PVA) as the inter-particle interaction modifier. The total ash content of the solution is 12% (based on equivalent weight of SiO₂ produced). The ratio of silane-based binder to silica particles (N-hexyltriethoxysilane:IPA-ST-S particles) is 60:40 ash content contribution. N-hexyltriethoxysilane and silica particles are mixed with water (2 times the molar n-hexyltriethoxysilane amount), sulfuric acid (5 times the molar n-hexyltriethoxysilane amount), ethanol, and polyvinylalcohol (between 0.001 wt. % and 1 wt. %). The solution is stirred for 24 hours at room temperature.

The aforementioned sol formulations may be deposited using either dip (coating speed˜10 mm/sec) or spin coating (100-4,000 rpm) processes on pre-cleaned borosilicate (BSG) or sodalime glass to achieve a film thickness of around ˜150 nm after annealing. The glass substrate may then be dried at 150 degrees Celsius for 30 minutes in an oven to evaporate all the solvent and then annealed at 625-650 degrees Celsius for 6 minutes. The glass substrate may be cooled on a steel slab and characterized to determine the film thickness, refractive index (RI) and improvement in transmittance of light.

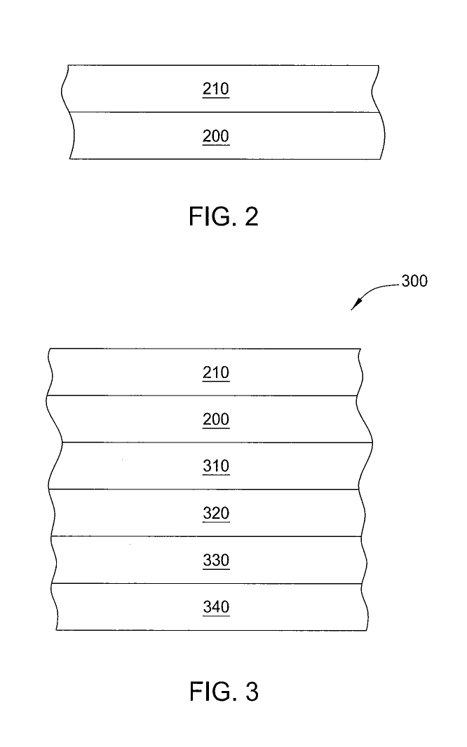

FIG. 2 is a schematic diagram illustrating one embodiment of a porous antireflective coating (ARC) 210 on a glass substrate 200 according to embodiments described herein. The porous antireflective coating 210 was produced using sol-formulations comprising the silane-based binder, silica-based nanoparticles, and an inter-particle interaction modifier as described herein.

FIG. 3 is a schematic diagram illustrating one embodiment of a photovoltaic cell 300 comprising a porous antireflective coating formed from the sol-formulations comprising the silane-based binder, silica-based nanoparticles, and the inter-particle interaction modifier as described herein. The photovoltaic cell 300 comprises the glass substrate 200 and the porous antireflective coating as shown in FIG. 2. In this exemplary embodiment, the incoming or incident light from the sun or the like is first incident on the AR coating 210, passes therethrough and then through the glass substrate 200 and front transparent conductive electrode 310 before reaching the photovoltaic semiconductor (active film) 320 of the solar cell. The photovoltaic cell 300 may also include, but does not require, a reflection enhancement oxide and/or EVA film 330, and/or a back metallic or otherwise conductive contact and/or reflector 340 as shown in FIG. 3. Other types of photovoltaic devices may of course be used, and the photovoltaic device 300 is merely exemplary. As explained above, the AR coating 210 may reduce reflections of the incident light and permits more light to reach the thin film semiconductor film 320 of the photovoltaic device 300 thereby permitting the device to act more efficiently.

While the foregoing is directed to embodiments of the invention, other and further embodiments of the invention may be devised without departing from the basic scope thereof.

What is claimed is:

1. A method of forming a porous coating on a substrate, comprising:
coating a substrate with a sol-formulation comprising:
a silane-based binder;
silica-based nanoparticles; and
an inter-particle interaction modifier for regulating interactions between the silica-based nanoparticles; and
forming a gel on the substrate by drying the sol-formulation coated on the substrate.

2. The method of claim 1, wherein the inter-particle interaction modifier is selected from the group consisting of: a polymer that adsorbs onto the silica-based nanoparticles, a soluble polymer that causes depletion attraction forces between the silica-based nanoparticles, electrolytes, and combinations thereof.

3. The method of claim 2, wherein the polymer that adsorbs onto the silica-based nanoparticles is selected from the group consisting of: polymethylmethacrylate (PMMA), dextrin, cationic surfactants, anionic surfactants, and combinations thereof.

4. The method of claim 2, wherein the soluble polymer that causes depletion attraction forces between the silica-based nanoparticles is selected from the group consisting of: sodium poly(styrenesulfonate), polyvinylalchol (PVA), sodium carboxymethyl cellulose (CMC), sodium polystyrene sulfonate (SPSS), and combinations thereof.

5. The method of claim 2, wherein the electrolytes are selected from the group consisting of: sodium chloride, potassium chloride, sodium nitrate, potassium nitrate, potassium bromide, potassium iodide, potassium sulfate, ammonium chloride, lead nitrate, and combinations thereof.

6. The method of claim 1, wherein the silane-based binder is selected from the group consisting of: tetraethylorthosilicate (TEOS), tetramethylorthosilicate (TMOS), 3-glycidoxypropyltrimethoxysilane (Glymo), and combinations thereof.

7. The method of claim 1, further comprising:
annealing the coated substrate.

8. The method of claim 1, wherein the silica-based nanoparticles have a shape selected from spherical, pearl-shaped, disk-shaped, elongated, and combinations thereof.

9. The method of claim 1, wherein the sol-formulation comprises:
from about 0.01 wt. % to about 20 wt. % of the silane-based binder;
from about 0.01 wt. % to about 20 wt. % of silica-based nanoparticles;
from about 0.001 wt. % to about 1 wt. % of the inter-particle interaction modifier;
from about 80 wt. % to about 95 wt. % of an alcohol containing solvent; and
from about 0.001 wt. % to about 0.1 wt. % of an acid or base containing catalyst.

10. A sol-formulation for forming a sol-gel, comprising:
an alcohol containing solvent;
an acid or base containing catalyst;
a silane based binder;
silica-based nanoparticles, and
an inter-particle interaction modifier for regulating interactions between the silica-based nanoparticles.

11. The sol-formulation of claim 10, wherein the inter-particle interaction modifier is selected from the group consisting of: a polymer that adsorbs onto the silica-based nanoparticles, a soluble polymer that causes depletion attraction forces between the silica-based nanoparticles, an electrolyte, and combinations thereof.

12. The sol-formulation of claim 11, wherein the polymer that adsorbs onto the silica-based nanoparticles is selected from the group consisting of: polymethylmethacrylate (PMMA), dextrin, cationic surfactants, anionic surfactants, and combinations thereof.

13. The sol-formulation of claim 11, wherein the soluble polymer that causes depletion attraction forces between the silica-based nanoparticles is selected from the group consisting of: sodium poly(styrenesulfonate), polyvinylalchol (PVA), sodium carboxymethyl cellulose (CMC), sodium polystyrene sulfonate (SPSS), and combinations thereof.

14. The sol-formulation of claim 11, wherein the electrolytes are selected from the group consisting of: sodium chloride, potassium chloride, sodium nitrate, potassium nitrate, potassium bromide, potassium iodide, potassium sulfate, ammonium chloride, lead nitrate, and combinations thereof.

15. The sol-formulation of claim 10, wherein the silane-based binder is selected from the group consisting of: tetraethylorthosilicate (TEOS), tetramethylorthosilicate (TMOS), 3-glycidoxypropyltrimethoxysilane (Glymo), n-hexyltriethoxysilane, cyclohexyltrimethoxysilane, and combinations thereof.

16. The sol-formulation of claim 10, wherein the silane-based binder is tetraethylorthosilicate (TEOS), the alcohol containing solvent is n-propyl alcohol (NPA), the inter-particle interaction modifier is potassium chloride, and the acid or base containing catalyst is acetic acid.

17. The sol-formulation of claim 10, wherein the silica-based nanoparticles have a shape selected from spherical, pearl-shaped, disk-shaped, elongated, and combinations thereof.

18. The sol-formulation of claim 10, wherein the sol-formulation comprises:
from about 0.01 wt. % to about 20 wt. % of the silane-based binder;
from about 0.01 wt. % to about 20 wt. % of silica-based nanoparticles;
from about 0.001 wt. % to about 1 wt. % of the inter-particle interaction modifier;
from about 80 wt. % to about 95 wt. % of the alcohol containing solvent; and
from about 0.001 wt. % to about 0.1 wt. % of the acid or base containing catalyst.

19. A method of making a sol-formulation, comprising:
mixing a silane-based binder, an acid or base containing catalyst, silica-based nanoparticles, an alcohol containing solvent, and an inter-particle interaction modifier for regulating interactions between the silica-based nanoparticles to form a reaction mixture by at least one of a hydrolysis and polycondensation reaction.

20. The method of claim 19, wherein the inter-particle interaction modifier is selected from the group consisting of: a polymer that adsorbs onto the silica-based nanoparticles, a soluble polymer that causes depletion attraction forces between the silica-based nanoparticles, electrolytes, and combinations thereof.
